(19) United States
(12) Patent Application Publication
(10) Pub. No.: US 2025/0392106 A1
(43) Pub. Date: Dec. 25, 2025

(54) LID ASSEMBLY FOR PULL BOXES

(71) Applicant: JCS Innovations LLC, Las Vegas, NV (US)

(72) Inventors: John MAYORGA, Las Vegas, NV (US); Rujake GROSS, Caliente, NV (US)

(21) Appl. No.: 19/092,269

(22) Filed: Mar. 27, 2025

Related U.S. Application Data
(60) Provisional application No. 63/663,381, filed on Jun. 24, 2024.

(51) Int. Cl. H02G 3/14; H02G 3/08

(52) U.S. Cl. CPC H02G 3/14; H02G 3/081

(57) ABSTRACT

A lid assembly for locking a buried pull box. The lid assembly includes a ground frame for being positioned in the ground above the pull box and configured to surround the pull box and to be anchored in the ground. A frame lid is positioned inside the ground frame. The frame lid has an outer wall of a metal material and defines a hollow filled with a concrete for making the frame lid heavy to inhibit movement of the frame lid from the ground frame.

### CROSS REFERENCE TO RELATED APPLICATIONS

This utility patent application claims the benefit of and priority to U.S. Provisional Patent Application Ser. No. 63/663,381, filed on Jun. 24, 2024, U.S. Provisional Patent Application Ser. No. 63/689,214, filed on Aug. 30, 2024, and U.S. Provisional Patent Application Ser. No. 63/756,314, filed on Feb. 10, 2025, the entire disclosures of which are hereby incorporated by reference in its entirety.

### TECHNICAL FIELD

The subject invention relates to subterranean pull boxes, such as those used to hold utility equipment, like electrical wires. More particularly, the subject invention relates to a lid for preventing tampering with, and theft from subterranean pull boxes.

### BACKGROUND

Pull boxes are commonly used in the utility industry to store and manage utility equipment, like electrical wires, allowing for selective access when needed. To address issues of vandalism and theft, heavy lids have been implemented to protect the electrical components housed within these pull boxes. Traditionally, these lids are made of solid concrete and are placed atop the pull boxes to provide a robust barrier against unauthorized access.

However, despite the use of heavy concrete lids, vandals have still been able to break the concrete and move the lids, thereby compromising the security of the electrical components. This ongoing issue highlights the limitations of current designs and underscores the need for improved solutions to enhance the protection of pull boxes.

Therefore, there is a clear and pressing need for advancements in the design of pull box lids to better safeguard the electrical components from vandalism and theft.

### SUMMARY

According to an aspect of the disclosure, a lid assembly is provided for locking a buried pull box. The lid assembly includes a ground frame for being positioned in the ground above the pull box and configured to surround the pull box and to be anchored in the ground. A frame lid is positioned inside the ground frame. The frame lid has an outer wall of a metal material and defines a hollow filled with a concrete for making the frame lid heavy to inhibit movement of the frame lid from the ground frame.

According to another aspect of the disclosure, a pull box assembly includes a pull box that is buried in the ground. The pull box has sidewalls with a bottom at a first end of the sidewalls, and an open top at a top of the sidewalls opposite the bottom. A box lid is removeably coupled to the open top of the pull box. A ground frame for being positioned in the ground is positioned above the pull box and configured to surround the pull box. The ground frame is configured to be anchored in the ground. A frame lid is positioned inside the ground frame. The frame lid has an outer wall of a metal material and defines a hollow filled with a concrete for making the frame lid heavy to inhibit movement of the frame lid from the ground frame.

The lid assembly provides redundant anti-tampering devices to prevent unauthorized access to the pull box. Not only does the design enhance security, but it also provides convenient and secure management of the contents of the pull box.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a side cross-sectional view of an embodiment of a lid assembly and buried pull box, according to an aspect of the disclosure;

FIG. 2 is a perspective view of the lid assembly;

FIG. 3 is a perspective, exploded view of the lid assembly;

FIG. 4 is a perspective view of a ground frame of the lid assembly;

FIG. 5 is a perspective view of a lock bar of the lid assembly;

FIG. 6 is a perspective view of a lock box and flange of the lock bar;

FIG. 7 is a perspective view of the lock box of the lock bar;

FIG. 8 is a perspective view of the flange of the lock bar;

FIG. 9 is a perspective view of a lid of the lid assembly;

FIG. 10 is a front view of an anchor of the lid assembly;

FIG. 11 is a perspective view of a curb frame of the lid assembly; and

FIG. 12 is a perspective view of a spacer of the lid assembly.

### DESCRIPTION OF EMBODIMENTS

Referring to the figures, wherein like numerals indicate corresponding parts throughout the several views, a lid assembly 20 for buried pull boxes 22 is generally shown. The teachings of the subject disclosure may be used in conjunction with various types of pull boxes 22 such as those used in the utility industry to store and manage electrical wires 24. The subject lid assembly prevents unauthorized access to and tampering with the pull box 22, ensuring it is accessed only by predetermined parties when needed.

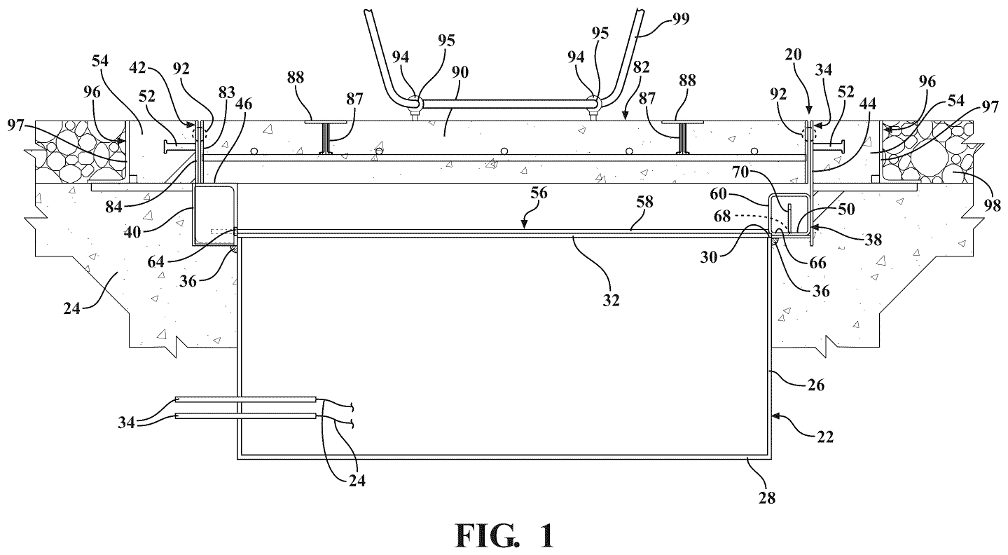

With reference to FIG. 1, the pull box 22 is buried in the ground 23. The pull box 22 has a sidewall 26 that extends between a closed bottom 28 and an open top 30. A box lid 32 removeably closes the open top 30 to open and close the pull box 22. One or more conduits 34 may extend through the side wall 26 of the pull box 22 for delivering the wires 24 into the pull box 22.

A ground frame 34 is positioned in the ground 24 above the pull box 22 and surrounds the pull box 22. According to an aspect of the disclosure, the ground frame 34 may be welded to the pull box 22 to provide a strong connection between the ground frame and the pull box. As illustrated in FIG. 1, the weld 36 may be located at various locations at the interface between the pull box 22 and ground frame 34.

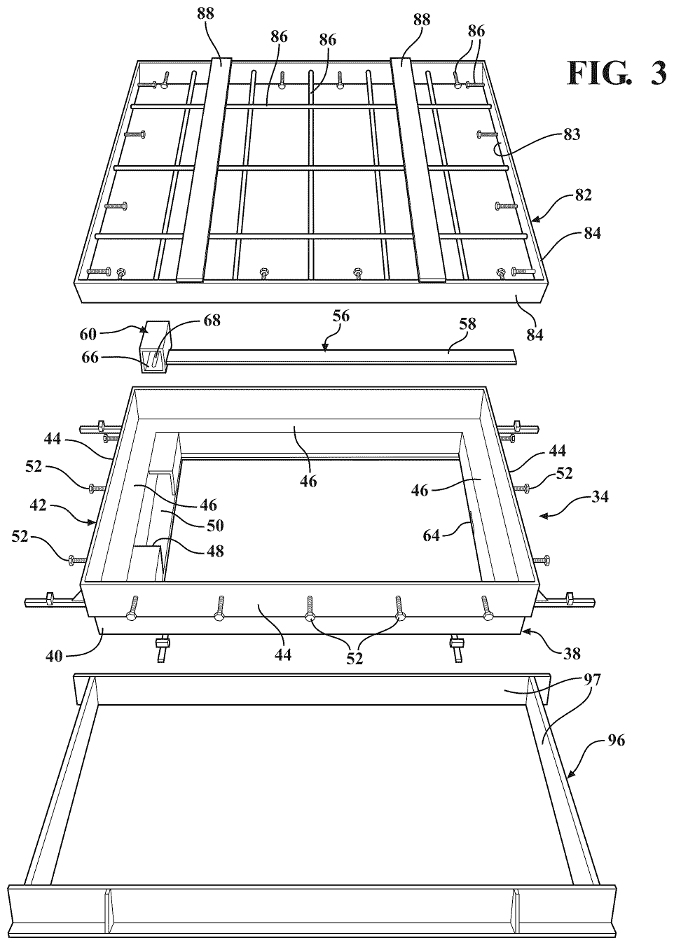

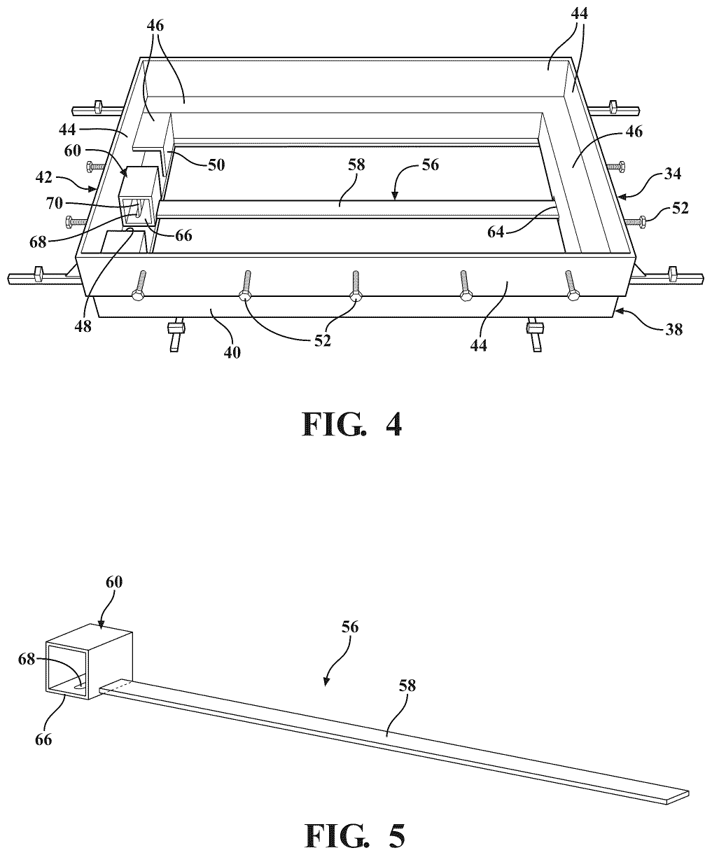

As best shown in FIGS. 1 and 3-4, the ground frame 34 has a lower segment 38 that is comprised of four lower vertical walls 40 arranged in a box shape. The ground frame 34 also has an upper segment 42 that is also comprised of four upper vertical walls 44 arranged in a box shape. The lower and upper segments 38, 42 may have other shapes. Two or more of the upper vertical walls 44 of the upper segment 42 are located outwardly relative to the lower segment 38 such that at least a portion of the upper segment 42 surround the lower segment 42 in an outward direction. A horizontal shelf 46 is located between the lower and upper segments 38, 42 to connect the lower and upper segments 38, 42. The horizontal shelf 46 defines a cutout 48 along one side such that the side of the shelf 46 is comprised of two segments with a gap therebetween. A lower shelf 50 is located along the region of the cutout 48. A plurality of anchors 52 (e.g., rebar segments) extend outwardly from the upper vertical walls 44 of the upper segment 42 for anchoring the ground frame 34 in poured concrete 54 which surrounds the ground frame (FIG. 1).

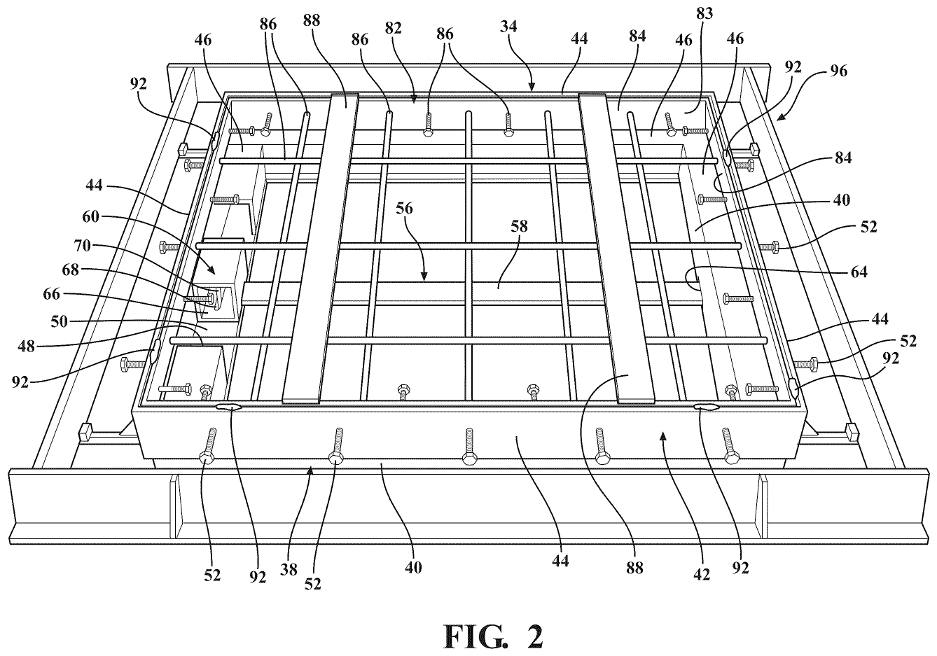

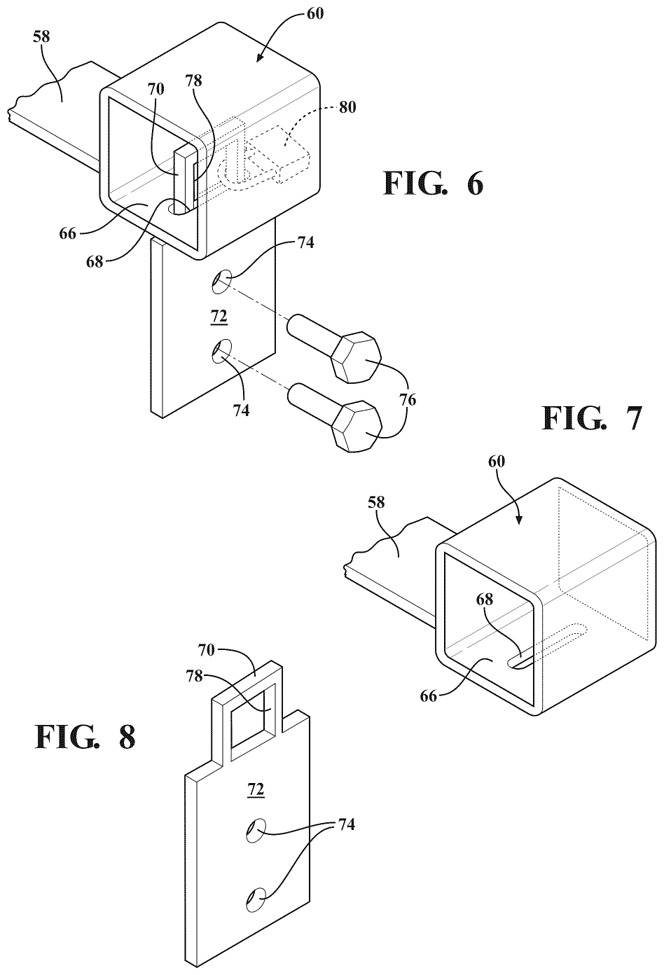

As best shown in FIGS. 1-2 and 4-8, a lock bar 56 overlies the box lid 32 to secure the box lid 32 in place as an added layer of protection to prevent unauthorized access to the pull box 22. The lock bar 56 includes an elongated bar segment 58 which terminates at a hollow lock box 60. A bottom of the lock bar 56 is configured to overlie the box lid 32. A terminal end of the bar segment 58 opposite the lock box 60 is configured to fit into a side slot 64 of the lower segment 38 of the ground frame 34 to inhibit upward movement of the lock bar 56 at the terminal end of the bar segment 58. A bottom surface 66 of the lock box 60 defines a bottom slot 68. A flange 70 is fixed to the ground frame 34 beneath the lower segment 38 and extends upwardly from the lower shelf 50 and into the slot 68 of the lock box 60. As best shown in FIG. 6A bottom portion 72 of the flange 70 is fixedly bolted, welded, or otherwise secured to the ground frame 34 beneath the lower shelf 50, such as via fasteners 76 such as bolts which extend through orifices 74 on the bottom portion 72 of the flange 70. The flange defines a passage 78 for receiving a lock 80, e.g., a padlock, to lock the lock bar 56 in place. The lock 80 further limits access to the pull box 22 to only authorized users.

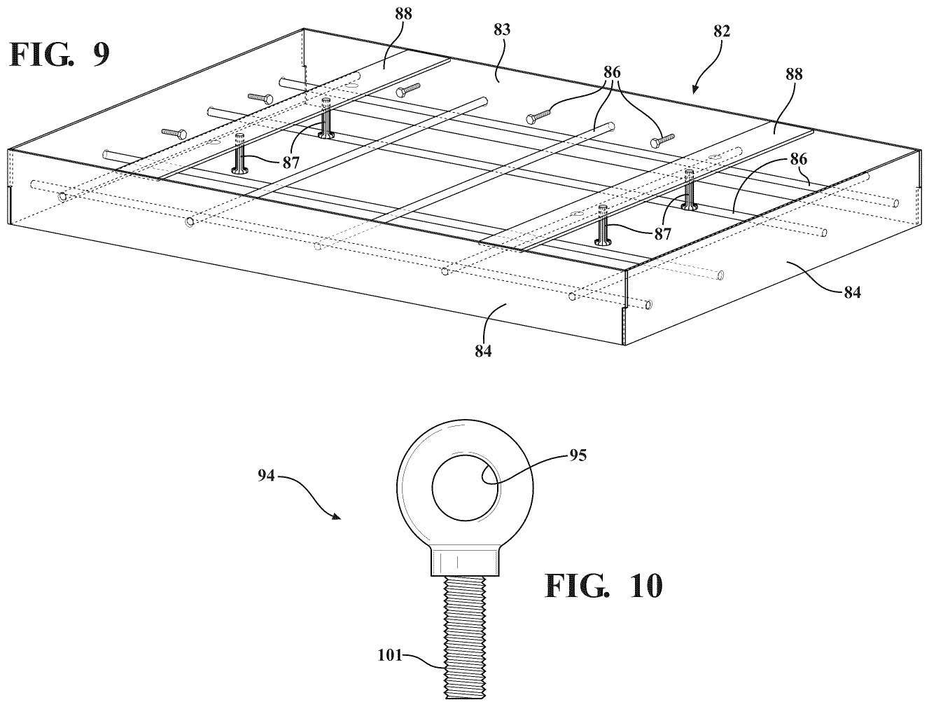

As best shown in the FIGS. 1-3 and 9, a heavy lid 82 is configured to be positioned inside the ground frame 34. The lid 82 has an outer wall 84 comprised of a series of panels of a steel material which define a hollow 83. A plurality of horizontal rebar segments 86 extend transversely across the lid 82 between outer walls 84 in two directions. The horizontal rebar segments 86 may also take the form of bolts 86 which extend a predetermined length into the hollow 83 of the outer wall 84. A pair of elongated plates 88 extend across a width of the outer walls 84. Vertical rebar segments 87 extend downwardly from the elongated plates 88. The lid 82 is configured to receive poured concrete 90 (FIG. 1) or the like into the hollow 83 to solidify the lid 82, with the rebar segments 86, 87 anchoring the concrete 90 in place. Once assembled, the lid 82 is configured to be positioned over the horizontal shelf 46 of the ground frame 34 and inside the ground frame 34. The outer wall 84 of the lid 82 may be welded to the ground frame 34 once in position. As shown, welds 92 may be located at various locations along the interface between the lid 82 and ground frame 34. This makes the lid 82 heavy and robust, and thus difficult to remove without specialized equipment.

As shown in FIGS. 1 and 10, a series of anchors 94 may be secured, e.g., threaded, to a top of the lid 82, e.g., in the concrete 90, via threads 101 to permit the lid to be removed via specialized equipment. For instance, a cable 99 may pass through orifices 95 of the anchors 94 to permit the lid 82 to be picked up with machinery via the cable 99. Any number of anchors 94 may be positioned on the top of the lid 82 in various arrangements. The anchors 94 may be secured to the lid 82 in other ways, such as via welding to the outer wall 84.

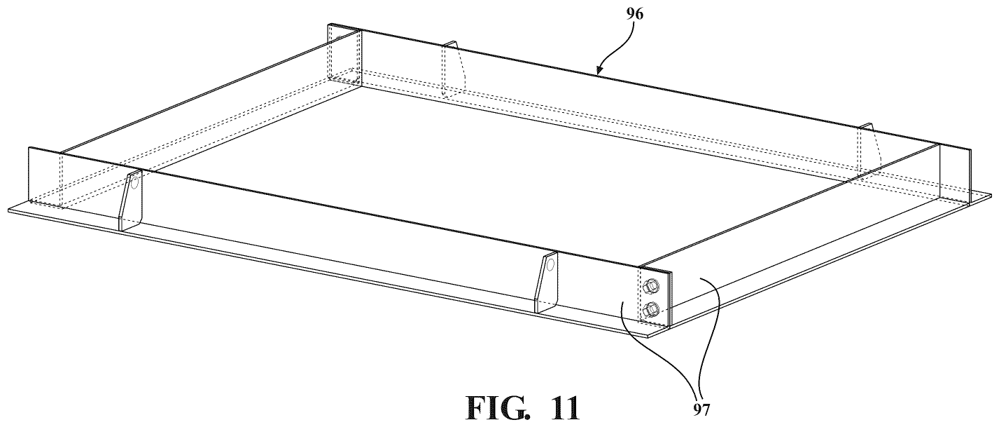

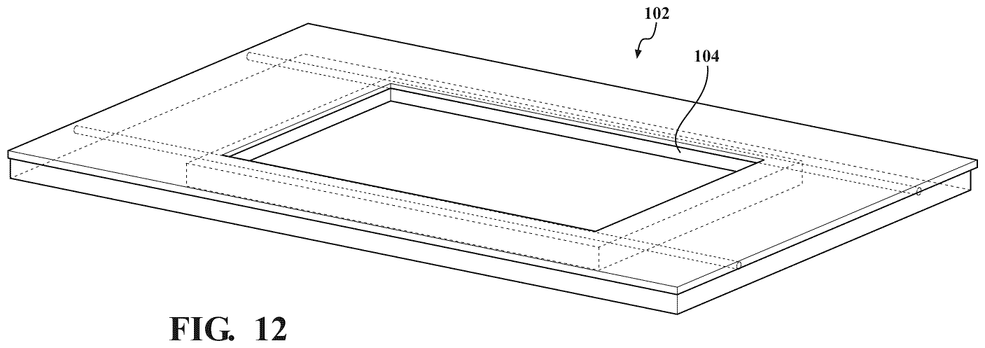

As shown in FIGS. 1-3 and 11, an outer curb frame 96 is buried in the ground about the ground frame 34. The outer curb frame 96 is comprised of a series of metal panels 97. Concrete 90 is poured between the outer curb frame and the ground frame 34 to secure the ground frame 34 in place by way of the anchors being sealed in the concrete. Gravel 98 is poured outwardly of the curb frame 96.

As best shown in FIGS. 1-3 and 11, a generally rectangular-shaped adapter plate 102 with a central opening 104 may be positioned between the pull box 22 and the ground frame 34 for occupying space between the pull box 22 and the ground frame 34 in the event that the pull box 22 is smaller than the ground frame 34. The adapter plate may have various shapes and sizes to accommodate differently sized and shaped pull boxes 22 and ground frames 34

In view of the foregoing, lid assembly 20 provides redundant anti-tampering devices by way of the features such as the rebar segments 52, welds 36, 92, lock bar 56 and heavy lid 82 to prevent unauthorized access to the pull box 22. Not only does the design enhance security, but it also provides convenient and secure management of the contents of the pull box 22.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in that particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or later, or intervening element or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to described various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in any embodiment, even if not specifically shown or described. The same may also be varied in many ways. Such variations are not to be regarded as a departure from the disclosure, and all such modifications are intended to be included within the scope of the disclosure.

What is claimed is:

1. A lid assembly for locking a buried pull box, comprising:
a ground frame for being positioned in the ground above the pull box and configured to surround the pull box and to be anchored in the ground;
a frame lid positioned inside the ground frame; and
the frame lid having an outer wall of a metal material and defining a hollow filled with a concrete for making the frame lid heavy to inhibit movement of the frame lid from the ground frame.

2. The lid assembly as set forth in claim 1, wherein the outer wall of the frame lid is welded to the ground frame for further securing the frame lid to the ground frame.

3. The lid assembly as set forth in claim 1, wherein a plurality of rebar segments extend across the outer wall of the frame lid for securing the concrete in place in the hollow of the frame lid.

4. The lid assembly as set forth in claim 3, wherein a plurality of elongated plates extend across a width of the outer wall of the frame lid for further securing the concrete in place in the hollow of the frame lid.

5. The lid assembly as set forth in claim 1, wherein at least one anchor protrudes upwardly from the frame lid for permitting the frame lid to be removed from the ground frame with specialized frame.

6. The lid assembly as set forth in claim 5, wherein the at least one anchor is coupled to the concrete of the frame lid.

7. The lid assembly as set forth in claim 1, wherein a plurality of anchors extend outwardly from the ground frame for anchoring the frame lid frame in poured concrete surrounding the ground frame.

8. The lid assembly as set forth in claim 1, wherein the ground frame has a lower segment comprised of a plurality of lower walls extending in a vertical direction, an upper segment comprised of a plurality of upper walls located outwardly of the lower segment and extending in the vertical direction, and wherein an upper horizontal shelf is located between the lower and upper segments and connecting the lower and upper segments, wherein the horizontal shelf extends in a horizontal direction being perpendicular to the vertical direction, wherein the frame lid is configured to sit on the shelf internal to the upper segment, and wherein an opening is defined internally to the lower walls.

9. The lid assembly as set forth in claim 8, wherein a lower shelf extends outwardly from a bottom edge of one of the lower walls, wherein the lower shelf extends in spaced and parallel relationship with the upper shelf, wherein the upper shelf defines a cutout to expose the lower shelf, wherein a lock bar extends across the opening and overlies the lower shelf to inhibit vertical movement of a frame lid of the pull box.

10. The lid assembly as set forth in claim 9, wherein the lock bar includes an elongated bar segment which terminates at lock box at a first end, wherein the lock box is selectively lockable to the lower shelf, wherein the lock bar has a terminal end opposite the lock box, and wherein the lower segment defines a side slot configured to receive the terminal end of the lock bar to fix the terminal end to the ground frame.

11. The lid assembly as set forth in claim 10, wherein a flange extends vertically upwardly from the lower shelf, wherein a bottom surface of the lock box defines a bottom slot for receiving the flange, and wherein the flange defines a passage for receiving a lock to secure the lock box to the lower shelf.

12. The lid assembly as set forth in claim 8 wherein a plurality of anchors extend outwardly from the upper segment of the ground frame for anchoring the frame lid frame in poured concrete surrounding the ground frame.

13. The lid assembly as set forth in claim 1 wherein an outer curb frame surrounds the ground frame for being buried in the ground such that concrete can be poured between the curb frame and the ground frame to secure the ground frame and frame lid in place.

14. A pull box assembly, comprising:
A pull box buried in the ground and having sidewalls with a bottom at a first end of the sidewalls, and an open top at a top of the sidewalls opposite the bottom;
A box lid removeably coupled to the open top of the pull box;
a ground frame for being positioned in the ground above the pull box and configured to surround the pull box and to be anchored in the ground;
a frame lid positioned inside the ground frame; and
the frame lid having an outer wall of a metal material and defining a hollow filled with a concrete for making the frame lid heavy to inhibit movement of the frame lid from the ground frame.

15. The lid assembly as set forth in claim 14, wherein the outer wall of the frame lid is welded to the ground frame for further securing the frame lid to the ground frame.

16. The lid assembly as set forth in claim 14, wherein a plurality of rebar segments extend across the outer wall of the frame lid for securing the concrete in place in the hollow of the frame lid.

17. The lid assembly as set forth in claim 16, wherein a plurality of elongated plates extend across a width of the outer wall of the frame lid for further securing the concrete in place in the hollow of the frame lid.

18. The lid assembly as set forth in claim 14, wherein at least one anchor protrudes upwardly from the frame lid for permitting the frame lid to be removed from the ground frame with specialized frame.

19. The lid assembly as set forth in claim 14, wherein a plurality of anchors extend outwardly from the ground frame for anchoring the frame lid frame in poured concrete surrounding the ground frame.

20. The lid assembly as set forth in claim 14, wherein the ground frame has a lower segment comprised of a plurality of lower walls extending in a vertical direction, an upper segment comprised of a plurality of upper walls located outwardly of the lower segment and extending in the vertical direction, and wherein an upper horizontal shelf is located between the lower and upper segments and connecting the lower and upper segments, wherein the horizontal shelf extends in a horizontal direction being perpendicular to the vertical direction, wherein the frame lid is configured to sit on the shelf internal to the upper segment, and wherein an opening is defined internally to the lower walls.
